(19) United States
(12) Patent Application Publication
(10) Pub. No.: US 2010/0220050 A1
(43) Pub. Date: Sep. 2, 2010

(54) BACKLIGHT DEVICE AND DISPLAY DEVICE PROVIDED WITH THE SAME

(75) Inventor: Ryuhei Kishimoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/738,877

(22) PCT Filed: Oct. 14, 2008
(86) PCT No.: PCT/JP2008/068564

§ 371 Date: Apr. 20, 2010

(30) Foreign Application Priority Data
Oct. 23, 2007 (JP) 2007-275573

(51) Int. Cl. G09G 3/36

(52) U.S. Cl. 345/102

(57) ABSTRACT

The object is to decrease the size of an entire backlight device including an inverter circuit board and the cost for producing the backlight device. The backlight device includes a lamp (20a), an inverter circuit that generates a drive voltage for driving the lamp (20a) from an inputted voltage, a socket section (26a) that holds an end part of the lamp (20a) and applies the drive voltage to an electrode lead (28a) led out from the end part of the lamp (20a), and a metal chassis (31). The socket section (26a) has a dielectric (dielectric unit 32) between a flat part of the electrode lead (28a) of the lamp (20a) and the metal chassis (31). The electrode lead (28a), the dielectric (dielectric unit 32) and the metal chassis (31) function as a resonant capacitor of an output transformer of the inverter circuit.

### TECHNICAL FIELD

The present invention relates to a backlight device including a lamp to be driven by an inverter circuit, and a display device using the backlight device.

### BACKGROUND ART

In recent years, liquid crystal display devices having features such as low power consumption and being thin and lightweight have become widely used as liquid crystal display devices for televisions. A liquid crystal panel constituting a display element of a liquid crystal display device is a so-called non-emissive display element that does not emit light itself. Accordingly, a light source called a backlight device is normally provided at a rear surface of the liquid crystal panel, and image display is performed by controlling the transmission of light from this backlight device with the liquid crystals.

Here, as for the backlight of a liquid crystal display device, a surface-emitting backlight device having uniform luminance and colors over an entire surface of an image display area of the liquid crystal panel is desired, and two methods, namely a direct light method and an edge light method are known as methods for realizing such a surface-emitting backlight.

The direct light method involves arranging a plurality of fluorescent tubes serving as backlight light sources in parallel at a rear surface of the liquid crystal panel, and using light irradiated from the fluorescent tubes as a surface-emitting light source whose luminance is uniformized by mediating a diffusion plate, a lens sheet or the like. On the other hand, with the edge light method (also called a side light method), the backlight is composed of a light-guiding plate whose shape corresponds to the image display area of the liquid crystal panel, and a fluorescent tube provided opposite a lateral surface of this light-guiding plate, and involves using light from the fluorescent tube that is incident from the lateral surface of the light-guiding plate as a surface-emitting light source by repeatedly reflecting and propagating this light within the light-guiding plate, and ultimately emitting the light on the liquid crystal panel side.

In a liquid crystal display device that is used for a television set and that is provided with a liquid crystal panel of 20 inches or more, a direct type backlight device is used in general since such a direct type backlight device has an advantage that the size can be reduced and the luminance can be improved in comparison with an edge light type device. Moreover, the direct type backlight device has a hollow structure inside thereof, and has a light weight even if increasing its size, thereby being suitable for increasing the luminance and the size.

For fluorescent tubes used in such direct type backlight devices, cold cathode fluorescent tubes (CCFTs) often have been used. For a circuit for lighting/driving such a cold cathode fluorescent tube, an inverter circuit, which boosts the commercial alternating voltage as an input voltage with an inverter-transformer so as to obtain an operation voltage, has been used.

FIG. 6 is a schematic block diagram showing connected parts between an inverter circuit 51 and cold cathode fluorescent tubes 20a, 20b as lamps (light sources) in a conventional backlight device. In FIG. 6, electrodes of the two cold cathode fluorescent tubes 20a, 20b at the side not being applied with the drive voltage are connected to each other to be used as if they were a single U-shaped fluorescent tube. This is a connection in a so-called pseudo U-shaped tube connection method.

As shown in FIG. 6, at the output terminal of the inverter circuit 51, inverter-transformers 52, 53 are provided for corresponding to the cold cathode fluorescent tubes 20a, 20b respectively. A secondary coil 52b of the inverter-transformer 52 is connected to one electrode 20a1 of the cold cathode fluorescent tube 20a via a socket section 56a, and a secondary coil 53h of the inverter-transformer 53 is connected to one electrode 20b1 of the cold cathode fluorescent tube 20b via a socket section 57a. A so-called separately-excited inverter circuit is employed for the inverter circuit 51, and resonant capacitors 55a, 55b are connected to the secondary coils 52b, 53b of the inverter-transformers 52, 53. The low-voltage sides of the secondary coils 52b, 53b of the two inverter-transformers 52, 53 are grounded at the node 54. The circuit structure is not shown in FIG. 6 or not described in detail for the region from the input terminal of the inverter circuit 51 to the primary coils 52a, 53a of the inverter-transformers 52, 53.

As described above, in the so-called pseudo U-shaped tube connection method as shown in FIG. 6, an electrode 20a2 of the cold cathode fluorescent tube 20a at the side not being connected to the inverter-transformer 52 and an electrode 20b2 of the cold cathode fluorescent tube 20b at the side not being connected to the inverter-transformer 53 are connected to each other with an interconnect line 58 via the respective socket sections 56b and 57b.

Patent document 1 (FIG. 8) shows a circuit structure of a backlight device having an inverter circuit using a cold cathode fluorescent tube according to such a pseudo U-shaped tube connection method. Other than the pseudo U-shaped tube connection method, Patent document 2 and many other documents describe backlight devices using cold cathode fluorescent tubes and inverter circuits.

Patent document 1: JP 2002-231034 A
Patent document 2: JP 2001-110582 A

### DISCLOSURE OF INVENTION

### Problem to be Solved by the Invention

Here, a voltage of up to about 1000 to 2000 V is applied to a resonant capacitor to be mounted on the inverter circuit at the time of an operation. For this reason, it is required that the capacitor in use have a withstand voltage of at least 3000 V. As a result, the size of the capacitor will be increased and furthermore, the cost will be raised. Further, at the time of mounting the resonant capacitor on an inverter circuit substrate, spacing between high-voltage circuit wirings to be connected to the resonant capacitor should be kept for the purpose of avoiding short circuit or the like on the circuit board, and thus the size of the inverter circuit substrate will be increased.

Further, at the time of forming a backlight device by combining an inverter circuit and a cold cathode fluorescent tube, the resonant capacitor has been combined as a part of the inverter circuit on the inverter circuit substrate. As a result, even when the voltage characteristics of the cold cathode fluorescent tube varies, the variation cannot be adjusted at the inverter circuit. Therefore, it is impossible to cancel the luminance unevenness of the backlight device at the time of using a plurality of cold cathode fluorescent tubes disposed in parallel.

Therefore, with the foregoing in mind, it is an object of the present invention to decrease the size of an entire backlight device including an inverter circuit substrate and the cost for producing the backlight device, and to obtain a display device using such a backlight device.

### Means for Solving Problem

For achieving the above-mentioned object, a backlight device according to the present invention includes a lamp, an inverter circuit that generates from an inputted voltage a drive voltage for driving the lamp, a socket section that holds an end part of the lamp and applies the drive voltage to an electrode lead led out from the end part of the lamp, and a metal chassis. The socket section includes a dielectric between a flat part of the electrode lead of the lamp and the metal chassis. The electrode lead, the dielectric and the metal chassis function as a resonant capacitor of an output transformer of the inverter circuit.

Furthermore, a display device according to the present invention includes a display section and the backlight device according to the present invention, and the display section is irradiated with light from the backlight device.

### EFFECTS OF THE INVENTION

According to the present invention, a resonant capacitor to be connected to an output transformer of an inverter circuit can be formed, separately from the inverter circuit, by using an electrode lead of a lamp, a dielectric and a metal chassis of a backlight device within a socket section for holding the lamp. Therefore, in comparison with a case where a circuit member to compose an inverter circuit is used as a resonant capacitor, a backlight device that serves to reduce the cost and decrease the size of the entire backlight device including the inverter circuit substrate and also a display device using the backlight device can be provided.

### BRIEF DESCRIPTION OF DRAWINGS

FIG. 1 is a cross-sectional view showing a schematic configuration of a liquid crystal display device according to an embodiment of the present invention.

FIG. 2 is a block diagram showing connection between a lamp of a backlight device of the liquid crystal display device according to the embodiment of the present invention and an inverter circuit.

FIG. 3 is a cross-sectional view showing a configuration of a socket section of the backlight device according to the embodiment of the present invention.

FIG. 4 is a perspective view showing a configuration of an electrode lead part of the lamp of the backlight device according to the embodiment of the present invention.

FIG. 5 is a perspective view showing a configuration of a dielectric unit of the backlight device according to the embodiment of the present invention.

FIG. 6 is a block diagram showing a connection between a lamp of a backlight device and an inverter circuit of a conventional liquid crystal display device.

### DESCRIPTION OF THE INVENTION

A backlight device according to the present invention is a backlight device including an inverter circuit that generates from an inputted voltage a drive voltage for driving the lamp, a socket section that holds an end part of the lamp and applies the drive voltage to an electrode lead led out from the end part of the lamp, and a metal chassis. The socket section comprises a dielectric between a flat part of the electrode lead of the lamp and the metal chassis. And the electrode lead, the dielectric and the metal chassis function as a resonant capacitor of an output transformer of the inverter circuit.

Accordingly, the resonant capacitor is formed of a flat part of an electrode lead of a lamp as a light source, a dielectric and a metal chassis of a backlight device, separately from the inverter circuit. In this configuration, the cost can be reduced and a smaller inverter circuit can be provided in comparison with a case of using the resonant capacitor as an independent circuit member.

It is preferable in the backlight device that the dielectric is a removable dielectric unit. In the configuration, placement of the dielectric in a space between the flat part of the electrode lead of the lamp and the metal chassis of the backlight device becomes easier, and thus production of the backlight device becomes easier.

It is further preferable that the dielectric unit includes a solid dielectric material and holding sections for holding the same, or that the dielectric unit includes a liquid dielectric material and a container into which the liquid dielectric material is injected. Accordingly, various kinds of dielectric materials in the form of a solid or a liquid can be employed, and a dielectric having a desired cross-sectional area can be provided easily.

It is further preferable that the dielectric unit is selected in accordance with a voltage characteristic of the lamp so as to adjust the capacitance of the resonant capacitor. Accordingly, a luminosity unevenness caused by the voltage characteristic of the lamp can be reduced, and thus a backlight device with less unevenness in luminance can be obtained.

Further, it is preferable that the electrode lead has a flat part formed by flattening at least one part of the electrode line, or that the electrode lead has a flat part formed by connecting a flat metal plate to an electrode line. Accordingly, the surface area of an electrode lead that is led out from the lamp so as to function as an electrode of the resonant capacitor can be ensured.

It is further preferable that a cold cathode fluorescent tube is used for the lamp.

A display device according to the present invention includes a display section and the backlight device according to the present invention. The display section is irradiated with light from the backlight device of the present invention.

The thus provided display device according to the present invention benefits from the characteristics of the backlight device of the present invention, namely, the size and the production cost can be reduced.

Hereinafter, a preferred embodiment of the backlight device and the display device of the present invention will be described with reference to the attached drawings. It should be noted that the following description refers to an example where the display device of the present invention is a television receiver that includes a transmission type liquid crystal display element as the display section, but the description does not limit the scope to which the present invention is applied. For the display section of the present invention, for example, a semi-transparent liquid crystal display element can be used. Further, the display section is not limited to a liquid crystal panel, and any other display elements that display images by using illumination light from the backlight device as a light source can be used. Furthermore, the application of the display device of the present invention is not limited to such a television receiver.

### Embodiment

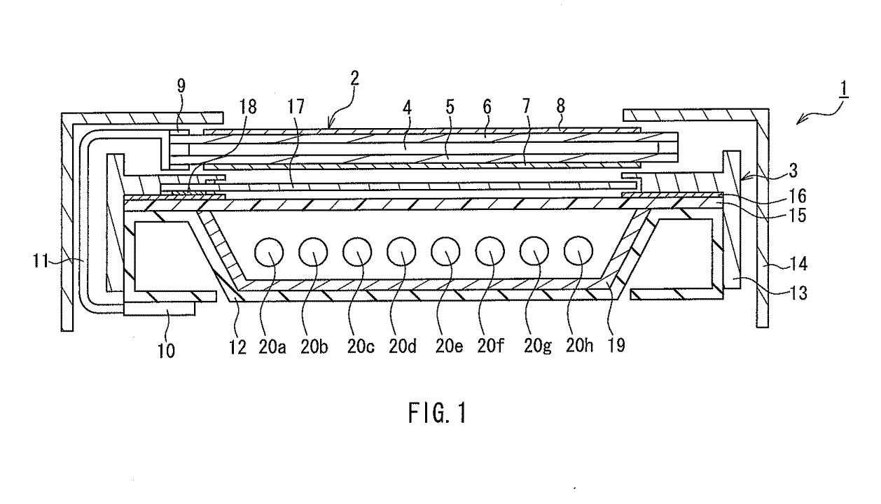

FIG. 1 is a schematic cross-sectional view for illustrating an embodiment of a backlight device according to the present invention and a liquid crystal display device including the same. As shown in FIG. 1, a liquid crystal display device 1 of the present embodiment includes a liquid crystal panel 2 (display section) disposed with its upper part in FIG. 1 as the viewed side (screen side) and a backlight device 3 arranged on the surface of the liquid crystal panel 2 opposite to the screen side (the lower part in FIG. 1) and irradiates the liquid crystal panel 2 with planar light.

The liquid crystal panel 2 includes a liquid crystal layer 4, a pair of transparent substrates 5, 6 that sandwich the liquid crystal layer 4, and polarizing plates 7, 8 that are provided respectively on the respective outer surfaces of the transparent substrates 5, 6. Further, a driver 9 for driving the liquid crystal panel 2 and a drive circuit 10 connected to the driver 9 via a flexible printed board 11 are provided on the liquid crystal panel 2.

The liquid crystal panel 2 is an active matrix type liquid crystal panel, which is configured to be capable of driving the liquid crystal layer 4 per pixel by supplying a scanning signal and a data signal to scanning lines and data lines arranged in matrix. Namely, when a TFT (switching element) provided in the vicinity of each intersection between the scanning line and the data line is turned ON by the signal of the scanning line, the alignment of the liquid crystal molecules changes in accordance with the potential level of the data signal to be written from the data line onto the pixel electrode, and thus each pixel displays a gradation corresponding to the data signal. On the liquid crystal panel 2, polarization of light entering from the backlight device 3 through the polarizing plate 7 is modulated by the liquid crystal layer 4, and the quantity of light passing the polarizing plate 8 is controlled, thereby displaying a desired image.

A box-like case 12 having an opening at the upper part in the drawing toward the liquid crystal panel 2 and a frame 13 attached to the case 12 facing the liquid crystal panel 2 are provided to the backlight device 3. The case 12 and the frame 13 are composed of metal or synthetic resin, and they are sandwiched by bezels 14 each having L-shaped cross-section, where the liquid crystal panel 2 is disposed above the frame 13. Thereby the backlight device 3 is assembled with the liquid crystal panel 2 so as to be integrated with each other as a transmission type liquid crystal display device 1 where illumination light from the backlight device 3 enters the liquid crystal panel 2.

The backlight device 3 includes a diffusion plate 15 disposed to cover the opening of the case 12, an optical sheet 17 disposed above the diffusion plate 15 so as to face the liquid crystal panel 2, and a reflective sheet 19 provided on the inner surface of the case 12. Further, cold cathode fluorescent tubes (CCFLs) 20 (20a-20h) as lamps (light sources) are provided to the backlight device 3 above the reflective sheet 19 at a predetermined pitch so as to be aligned substantially in the longitudinal direction. Light from these cold cathode fluorescent tubes 20 is irradiated as planar light toward the liquid crystal panel 2. Although FIG. 1 shows a configuration with eight cold cathode fluorescent tubes 20a, 20b, 20c, 20d, 20e, 20f, 20g, 20h for the purpose of simplicity, the number of the cold cathode fluorescent tubes is not limited to this example. For example, in a case of a liquid crystal display device for a television set whose screen size is 32 inches, fourteen cold cathode fluorescent tubes are arranged in parallel.

The diffusion plate 15 is composed of a synthetic resin or a glass material of about 2 mm in thickness, and it diffuses light from the cold cathode fluorescent tubes 20a-20h (including light reflected by the reflective sheet 19) and emits the light toward the optical sheet 17. Further the diffusion plate 15 is placed on a frame whose four sides are positioned above the case 12, and assembled with the interior of the backlight device 3 in a state being sandwiched between the surface of the case 12 and the inner surface of the frame 13 via an elastically-deformable pressing member 16. Further, the diffusion plate 15 is supported at its substantial center by a transparent supporting member (not shown) disposed on the reflective sheet 19, thereby being prevented from warping inward the case 12.

The diffusion plate 15 is held movably between the case 12 and the pressing member 16. As a result, even when elastic (plastic) deformation occurs on the diffusion plate 15 under the influence of heat caused by the heat release from the cold cathode fluorescent tubes 20a-20h or the temperature rise inside the case 12, the plastic deformation is absorbed by the elastic deformation of the pressing member 16, so that deterioration in the diffusion of light from the cold cathode fluorescent tubes 20a-20h is minimized. A diffusion plate 15 made of a glass material is used preferably since the glass material is superior to a synthetic resin in heat resistance and thus it is more resistant to warping, yellowing, thermal deformation or the like occurring under the influence of heat or the like.

The optical sheet 17 includes a focusing sheet composed of a synthetic resin film of about 0.5 mm in thickness for example, and it is formed to raise the luminance of illumination light from the backlight device 3 to the liquid crystal panel 2. On the optical sheet 17, optical sheet members such as a prism sheet, a diffusion sheet and polarizing sheet for improving the display quality or the like on the screen of the liquid crystal panel 2 are to be laminated appropriately as required. And the optical sheet 17 is configured to convert light emitted from the diffusion plate 15 to planar light having at least a predetermined (for example 10000 cd/m²) and uniform luminance, and allow the illumination light to enter the liquid crystal panel 2. The above-described configuration is not a sole example. Alternatively for example, an optical member such as a diffusion sheet for adjusting the viewing angle of the liquid crystal panel 2 can be laminated appropriately above the liquid crystal panel 2 (screen side).

A protrusion that protrudes to the left in FIG. 1 is formed on the optical sheet 17 at the center of the left side in FIG. 1, which will compose the upper part when the liquid crystal display device 1 is in use. In the optical sheet 17, the protrusion is sandwiched alone by the inner surface of the frame 13 and the pressing member 16 via an elastic material 18, and the optical sheet 17 is assembled inside the backlight device 3 in a stretchable state. Thereby, the optical sheet 17 can be stretched and deformed flexibly about the protrusion even when there occurs elastic (plastic) deformation under the influence of heat release or the like from the cold cathode fluorescent tubes 20a-20h, and thus wrinkles or warping that may occur in the optical sheet 17 can be minimized. As a result, in the liquid crystal display device 1, degradation in the display quality such as luminance unevenness that may occur on the screen of the liquid crystal panel 2 due to the warping or the like of the optical sheet 17 can be minimized.

The reflective sheet 19 is composed of for example a metal thin film of aluminum, silver or the like having a high optical reflectance and being about 0.2 to 0.5 mm in thickness, and it functions as a reflector that reflects light of the cold cathode fluorescent tubes 20a-20h toward the diffusion plate 15. Thereby, the backlight device 3 can raise the efficiency of light from the cold cathode fluorescent tubes 20a-20h and also the luminance at the diffusion plate 15. Alternatively, the metal thin film can be replaced by a reflective sheet material made of synthetic resin. Otherwise for example, the inner surface of the case 12 can be painted white or the like having a high reflectance so as to make the inner surface function as a reflector.

Each of the cold cathode fluorescent tubes 20a-20h in use is of a straight fluorescent lamp type with a decreased diameter of about 3.0 to 4.0 mm and with excellent luminous efficiency. Each of the cold cathode fluorescent tubes 20a-20h is held inside the case 12 while keeping a certain distance from the diffusion plate 15 and the reflection sheet 19 by a socket section (not shown). At the socket section, a drive voltage from the inverter circuit is applied to the electrodes of the cold cathode fluorescent tubes 20a-20h. Further, the cold cathode fluorescent tubes 20a-20h are arranged so that the longitudinal direction becomes parallel to a direction rectangular to a direction applied with the gravitation. Thereby, in the cold cathode fluorescent tubes 20a-20h, the mercury (vapor) sealed therein is prevented from being collected at one of the end parts in the longitudinal direction due to the action of the gravity, and thus the lamp life is improved remarkably.

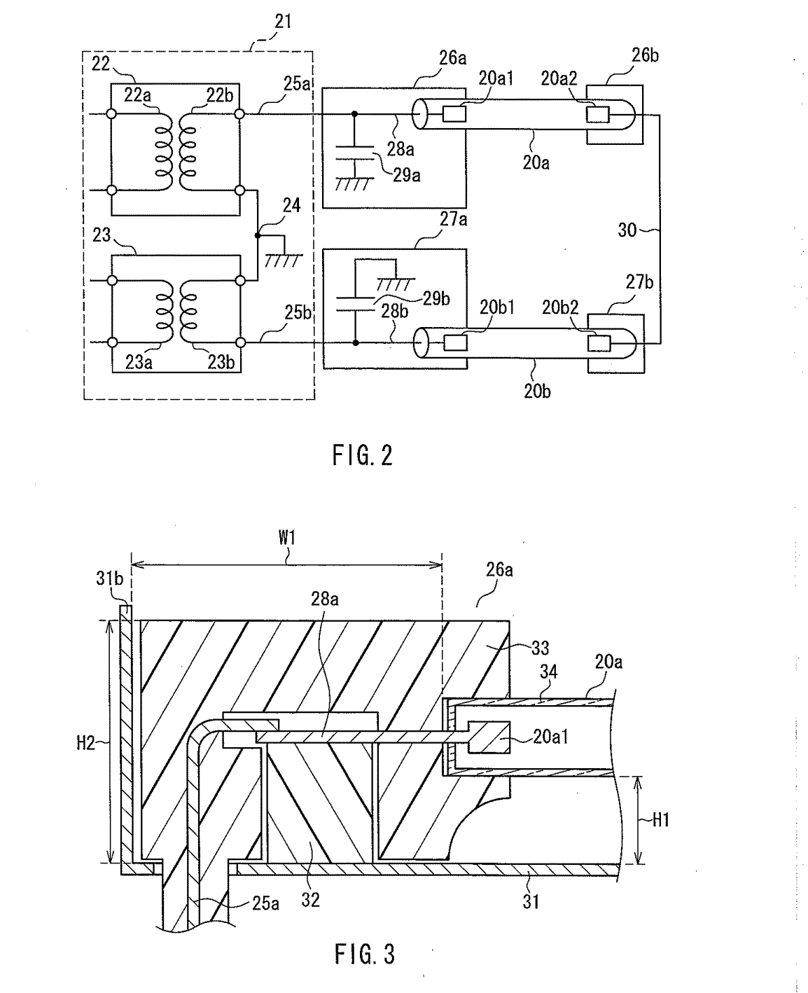

Next, a connection between a cold cathode fluorescent tube as a light source lamp of the backlight device according to the present embodiment, and an inverter circuit as a drive circuit for driving the same will be explained with reference to FIG. 2.

FIG. 2 is a schematic block diagram showing a connection of the cold cathode fluorescent tubes 20 (20a, 20b) of the backlight device according to the present embodiment and an inverter circuit 21 that generates a voltage for driving the same.

As shown in FIG. 2, in the backlight device according to the present embodiment, inverter-transformers 22, 23 are provided at the output terminal of the inverter circuit 21 so as to correspond respectively to the cold cathode fluorescent tubes 20a, 20b. A secondary coil 22b of the inverter-transformer 22 is connected to an electrode 20a1 of the cold cathode fluorescent tube 20a via a socket section 26a, and a secondary coil 23b of the inverter-transformer 23 is connected to an electrode 20b1 of the cold cathode fluorescent tube 20b via a socket section 27a.

A high-voltage terminal of the secondary coil 22b of the inverter-transformer 22 mounted on the inverter circuit 21 is connected to the electrode 20a1 of the cold cathode fluorescent tube 20a via the electrode lead 28a led out from the end part of the cold cathode fluorescent tube 20a in the socket section 26a by a harness 25a. Further, in the socket section 26a, a dielectric is arranged between a flat part of the electrode lead 28a and a metal chassis of the backlight device as a ground, thereby forming a resonant capacitor 29a. Similarly, a high-voltage terminal of the secondary coil 23b of the inverter-transformer 23 mounted on the inverter circuit 21 is connected to the electrode 20b1 of the cold cathode fluorescent tube 20b via an electrode lead 28b led out from the end part of the cold cathode fluorescent tube 20b in the socket section 27a by a harness 25b. Further, in the socket section 27a, a dielectric is arranged between a flat part of the electrode lead 28b and a metal chassis of the backlight device as a ground, thereby forming a resonant capacitor 29b.

Since the cold cathode fluorescent tubes 20 are connected in a so-called pseudo U-shaped tube connection method in the present embodiment, an electrode 20a2 of the cold cathode fluorescent tube 20a at the side not being connected to the inverter-transformer 22 and an electrode 20b2 of the cold cathode fluorescent tube 20b at the side not being connected to the inverter-transformer 23 are connected to each other with an interconnect line 30 via the respective socket sections 26b and 27b.

It should be noted that the connection of the cold cathode fluorescent tubes is not limited to the so-called pseudo U-shaped tube connection method as shown in FIG. 2 in the backlight device according to the present embodiment, and thus the electrode at the side not being connected to the inverter circuit of the cold cathode fluorescent tube is not necessarily connected to the electrode of the other cold cathode fluorescent tube.

In the backlight device according to the present embodiment, the configurations from the input terminal of the inverter circuit 21 to the primary coils 22a, 23a of the inverter-transformers 22, 23 are the same as the configurations employed for an inverter circuit of a conventional backlight device. Namely, the backlight device has a detector circuit for detecting a lamp current flowing actually in the cold cathode fluorescent tube, a feedback circuit and/or an adjustment circuit for keeping the lamp current constant, a stabilization circuit for stabilizing discharge at the cold cathode fluorescent tube and the operation of the inverter circuit itself, and the like. As these components are the same as those of the conventional inverter circuit, detailed explanations and illustration in the attached drawings are omitted. In FIG. 2, the low-voltage terminals of the secondary coils 22b, 23b of the two inverter-transformers 22, 23 are grounded at the node 24. This indicates just a concept of a circuit configuration. The low-voltage terminals of the secondary coils 22b, 23b of the two inverter-transformers 22, 23 are not necessarily grounded; generally in an actual circuit configuration, a feedback signal is taken from this node 24.

In FIG. 2, only the connected parts between the inverter circuits and the two cold cathode fluorescent tubes 20a, 20b are shown, and thus only two inverter-transformers (22, 23) are shown. However, the number of inverter-transformers is not limited to this example, but required number of inverter-transformers will be provided appropriately in accordance with, for example, the method of connecting the cold cathode fluorescent tubes.

FIG. 3 is a cross-sectional view showing the structure of the socket section 26b that holds the cold cathode fluorescent tube 20a and also applies a drive voltage to the electrode 20a1 of the cold cathode fluorescent tube 20a.

As shown in FIG. 3, the socket section 26a of the backlight device 3 according to the present embodiment has a removable dielectric unit 32 as a dielectric between the flat part of the electrode lead 28a that is connected to the electrode 20a1 of the cold cathode fluorescent tube 20a and led out from the cold cathode fluorescent tube and a metal chassis 31 that forms the case 12 serving as the bottom surface of the backlight device 3. The configuration of the electrode lead 28a and the configuration of the dielectric unit 32 will be described later.

The harness 25a is attached to the electrode lead 28a led out from the electrode 20a1 from the cold cathode fluorescent tube 20a, and through this harness 25a, a drive voltage is applied from the high-voltage terminal of the secondary coil 22b of the inverter-transformer 22 as an output terminal of the inverter circuit 21, to the electrode 20a1 of the cold cathode fluorescent tube 20a. And, the electrode 20a1 of the cold cathode fluorescent tube 20a, the dielectric unit 32, and the harness 25a that form the connection to the inverter circuit 21 are covered with a holder 33 made of an insulating and elastic material such as rubber and resin so as to prevent a short circuit caused by an electric connection to other components in the backlight device 3. Furthermore, a part of the holder 33 functions to wrap and hold a glass tube 34 as an end part of the cold cathode fluorescent tube 20a in the vicinity of the electrode 20a1.

The metal chassis 31 of the backlight device 3 functions also as the case 12 in the liquid crystal display device 1 as described in the present embodiment. In an alternative example, the case 12 is made of a resin and the metal chassis 31 is provided on the inner surface so as to compose a dual structure. Any of these examples can be employed for the backlight device of the present invention.

Normally the metal chassis 31 is grounded to be 0 V in order to prevent a floating potential from being charged or in consideration of the safety for the case where the chassis is exposed as a back cover for a TV set. Therefore, as described above, by providing a dielectric unit 32 between the flat part of the electrode lead 28a of the cold cathode fluorescent tube 20a and the metal chassis 31, the flat part of the electrode lead 28a, the dielectric unit 32 and the metal chassis 31 form a capacitor that will serve as a resonant capacitor 29a of the inverter-transformer 22.

In a specific example of the configuration as shown in FIG. 3, the socket section 26a can be configured to have the substantially same size as an electrode holding section of a cold cathode fluorescent tube used in a conventional backlight device. For example, when the outer diameter of the cold cathode fluorescent tube 20a is 4.0 mm, a spacing H1 between the cold cathode fluorescent tube 20a and the metal chassis 31 of the backlight device 3 is about 5 mm, a spacing W1 between the end part of the cold cathode fluorescent tube and a lateral wall 31b of a metal chassis 31 is about 10 mm, and a height H2 of the entire socket section is about 10 mm. Therefore, the resonant capacitor of the inverter-transformer can be included in the socket section without changing the size of the entire backlight device.

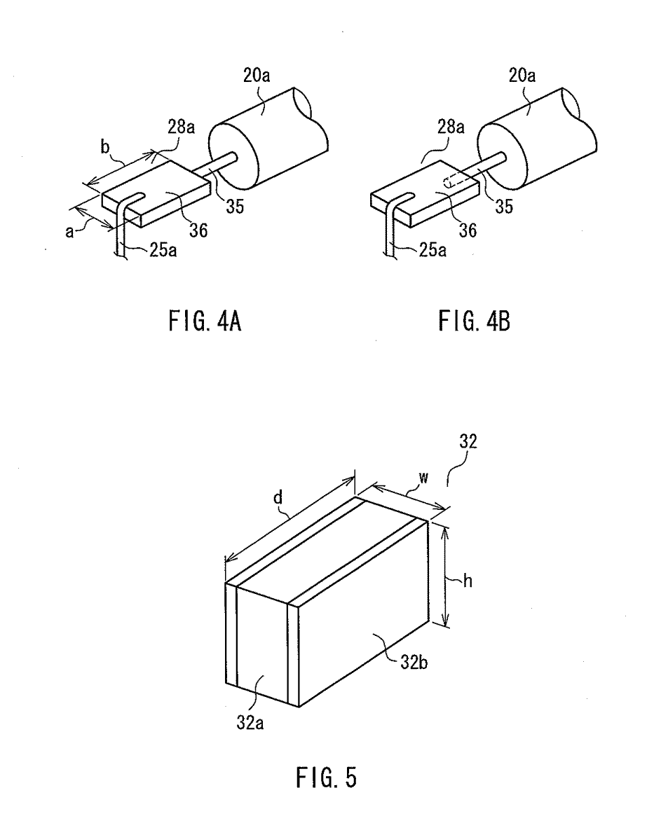

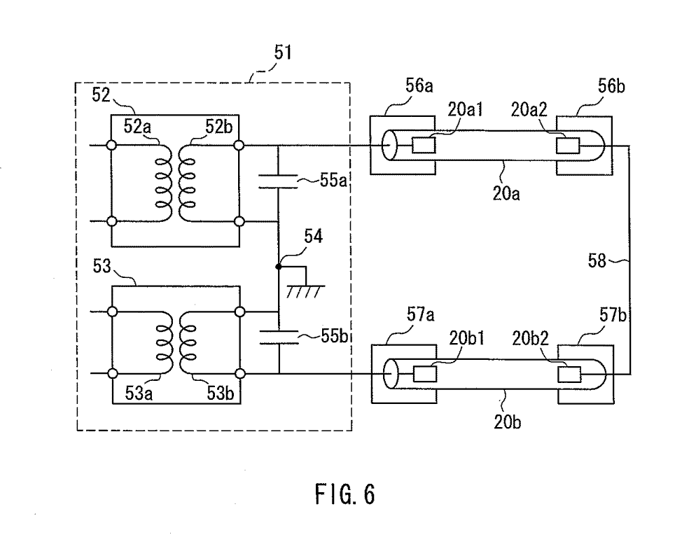

FIG. 4 is a magnified view showing an electrode lead of a cold cathode fluorescent tube of a backlight device according to the present embodiment.

As explained with reference to FIG. 3, since the flat part of the electrode lead of the cold cathode fluorescent tube in the backlight device according to the present embodiment is used as one electrode of the resonant capacitor, the electrode line connected to the electrode inside the cold cathode fluorescent tube is required to have a predetermined area for facing the metal chassis of the backlight device.

Therefore, as shown in FIG. 4A, the cold cathode fluorescent tube 20a used in the backlight device 3 according to the present embodiment has a flat part 36 formed by flattening a part of the electrode line 35 outside the tube so as to make a substantially rectangular flat plate. The harness 25a to be connected to the inverter circuit is connected to this flat part 36.

The electrode line 35 led out from the interior of the cold cathode fluorescent tube is shaped in general as a wire or a rod. Therefore, if it is impossible to flatten a part of the electrode line 35 to form the flat part 36, it is possible to connect a separate metal plate having a substantially-rectangular flat shape as shown in FIG. 4B to the typical electrode line 35 shaped as a fine rod, thereby providing a flat part 36 of the electrode lead 28a. In this case, the harness 25a is connected to the metal plate. Alternatively, it is possible to integrate the harness and the metal plate and to shape the tip of the harness to have a rectangular flat plate so as to form the flat part of the electrode lead, though not shown in the drawing. Needless to say that, for example, when the electrode lead itself has a flat part of a required size, for example when the electrode lead is a foil having a predetermined width, the above-mentioned processing of the electrode lead or the connection of a flat metal plate is not necessary.

It is preferred that the substantially-rectangular flat part is smaller so that the size of the holder including the electrode lead will not be increased and thus the size of the socket section will not be increased. For this reason, when a cold cathode fluorescent tube as mentioned above having an outer diameter of 4 mm is used for example, the width a of the flat part 36 is about 4-6 mm, and the length b is about 6-8 mm. Needles to say, the size of the flat part 36 varies depending on the value of C (capacitance) required for the resonant capacitor (about 1 to tens of pF in general) and the dielectric constant of the dielectric in use.

The above explanation refers to a case where the flat part of the electrode lead is substantially rectangular. The present invention is not limited to this example, and the shape can be circular, elliptic, triangular or polygonal. There is no particular limitation in the shape as long as a surface area sufficient to form a capacitor is ensured.

Next, the dielectric unit 32 will be described. As the dielectric material used for the socket section of the backlight device according to the present embodiment, any solid dielectric material such as barium titanate used for a capacitor as a normal circuit member can be used. Here, the size of the dielectric unit 32 is limited by the flat part formed on the electrode lead of the cold cathode fluorescent tube and a spacing between the electrode lead of the cold cathode fluorescent tube and the backlight chassis. For example, in the dielectric unit 32 of the present embodiment as shown in FIG. 5, the width w is 4-6 mm, the depth d is 6-8 mm, and the height h is 5-7 mm.

As described above, the size of the dielectric unit 32 is limited by the size of other members such as the flat part of the electrode lead of the cold cathode fluorescent tube, or by the height of the socket section. Specifically, it is preferred that the width wand the depth d of the dielectric unit 32 are equalized to the width a and the length b of the flat part of the electrode lead of the cold cathode fluorescent tube that is used in a state superposed with the dielectric unit 32 so as to function as the electrode of the capacitor. And the height h of the dielectric unit 32 becomes equal to the distance between the chassis of the backlight device and the electrode lead of the cold cathode fluorescent tube. Therefore, as shown in FIG. 5, the dielectric unit 32 according to the present embodiment is configured by sandwiching a dielectric body 32a as a solid dielectric material by a pair of holding sections 32b made of an insulator such as resin.

By providing the dielectric unit 32 in this manner, handleability of the dielectric body 32a made of barium titanate is improved. And when the dielectric body 32a is applied with external impact during handling thereof, the dielectric body 32a is protected so as to prevent change in the C (capacitance) value caused by the fluctuation in the dielectric constant due to the cracking or the like during serving as the resonant capacitor.

Furthermore, the dielectric is formed of a removable dielectric unit 32 that consists of the dielectric body 32a and the holding sections 32b. Therefore, by adjusting the respective thicknesses of the dielectric body 32a and the holding sections 32b, the dielectric constant can be varied without changing the appearance of the dielectric unit 32 even when solid materials having the same dielectric constant is used. Therefore, for example, when a plurality of cold cathode fluorescent tubes are arranged in parallel to be used as light sources, the voltage characteristics may vary among the individual cold cathode fluorescent tubes, namely, the output light quantity with respect to the same applied voltage may vary. In such a case, a dielectric unit 32 having a suitable capacitance as a resonant capacitor can be used to uniformize the quantity of light emitted from the respective cold cathode fluorescent tubes, thereby reducing the unevenness in the illumination light quantity for the backlight device.

Here, the dielectric unit 32 is prepared by covering the lateral faces of the dielectric body 32a with the holding sections 32b as shown in FIG. 5, but the appearance is not limited to this example. However, by forming the dielectric unit 32 so that the dielectric body 32a has a direct contact with each of the pair of electrodes as capacitors formed of the flat part of the electrode lead of the cold cathode fluorescent tube and the metal chassis of the backlight device, it is possible to avoid the influence of floating charge that may be generated in the holding sections 32b.

The dielectric material used for the dielectric unit according to the present embodiment is a simple barium titanate, but this is not a sole example and a mixture of a plurality of dielectric materials can be used. In place of the dielectric unit, a simple solid dielectric material can be arranged between the electrode lead of the cold cathode fluorescent tube and a metal chassis of the backlight.

Alternatively, a liquid dielectric material can be used for the socket section of the backlight device according to the present embodiment. In such a case, a container for containing the liquid dielectric material is used for the dielectric unit, into which the liquid dielectric material is injected. Here, by adjusting the concentration and amount of the dielectric material to be injected, the dielectric constant of the dielectric unit can be adjusted even by using the same liquid dielectric material. As a result, similarly to the case of using a solid dielectric material, the quantity of emitted light of the respective cold cathode fluorescent tubes can be uniformized, thereby providing a backlight device free of light quantity unevenness.

The dielectric unit as shown in FIG. 5 has upper and bottom surfaces shaped substantially rectangular. The shape corresponds to the shape of the flat part of the electrode lead functioning as the electrode of the capacitor. The shape of the upper and bottom surfaces of a dielectric to be integrated in the socket section of the backlight device according to the present invention is not limited to a substantial rectangle, but any appropriate shapes can be selected to correspond to the flat shape of the electrode lead. Needless to say, the shape is not necessarily the same as the shape of the flat part of the electrode lead.

In the embodiment of the present invention, the lamp as the light source is the cold cathode fluorescent tube. The present invention is not limited to this example, and a hot cathode fluorescent tube or any other lamps can be used.

The lamp is not limited to a straight tube having a circular cross section, but oblate lamps having elliptical or race-track shaped cross sections for enlarging the light discharge area can be used in order to improve the light emission efficiency.

Further, although an active matrix liquid crystal panel is used as the liquid crystal panel of the display section, the display part of the present invention is not limited to this example. Any other type liquid crystal panels such as a simple matrix type can be employed.

### INDUSTRIAL APPLICABILITY

The present invention can be utilized as a backlight device configured by forming a resonant capacitor of an inverter circuit inside a socket section for holding a lamp in order to reduce the size and the production cost, and also a display device including the backlight device as a planar light source.

1. A backlight device comprising: a lamp; an inverter circuit that generates from an inputted voltage a drive voltage for driving the lamp; a socket section that holds an end part of the lamp and applies the drive voltage to an electrode lead led out from the end part of the lamp; and a metal chassis,
the socket section comprises a dielectric between a flat part of the electrode lead of the lamp and the metal chassis, and
the electrode lead, the dielectric and the metal chassis function as a resonant capacitor of an output transformer of the inverter circuit.

2. The backlight device according to claim 1, wherein the dielectric is a removable dielectric unit.

3. The backlight device according to claim 2, wherein the dielectric unit comprises a solid dielectric material and holding sections for holding the solid dielectric material.

4. The backlight device according to claim 2, wherein the dielectric unit comprises a liquid dielectric material and a container into which the liquid dielectric material is injected.

5. The backlight device according to claim 1, wherein the dielectric unit is selected in accordance with a voltage characteristic of the lamp so as to adjust the capacitance of the resonant capacitor.

6. The backlight device according to claim 1, wherein the electrode lead has a flat part formed by flattening at least one part of an electrode line.

7. The backlight device according to claim 1, wherein the electrode lead has a flat part formed by connecting a flat metal plate to an electrode line.

8. The backlight device according to claim 1, wherein the lamp is a cold cathode fluorescent tube.

9. A display device comprising a display section and the backlight device according to claim 1,
the display section is irradiated with light from the backlight device.
